(19) United States
(12) Patent Application Publication
(10) Pub. No.: US 2015/0371430 A1
(43) Pub. Date: Dec. 24, 2015

(54) Identifying Imagery Views Using Geolocated Text

(71) Applicant: Google Inc., Mountain View, CA (US)

(72) Inventors: Brian Edmond Brewington, Fort Collins, CO (US); Brian Daniel Shucker, Superior, CO (US); Alexei Garianov, Golden, CO (US)

(21) Appl. No.: 14/310,029

(22) Filed: Jun. 20, 2014

(51) Int. Cl. G06T 15/20

(52) U.S. Cl. CPC G06T 15/20

(57) ABSTRACT

Systems and methods for identifying views for geographic imagery using geolocated text are provided. More specifically, a multi-resolution textual descriptors map associating text with specific geographic locations can be accessed and used to identify a viewpoint for displaying geographic imagery associated with an object of interest. The multi-resolution textual descriptors map can be a collection of data that associates text objects from the geolocated text with a plurality of varying zoom levels relative to the geographic area. The multi-resolution text map can provide labels of varying specificity based on the zoom level relative to the geographic area. Geographic locations and/or zoom levels corresponding to a text object describing or otherwise associated with the object of interest can be identified from the multi-resolution textual descriptors map. A view encompassing the identified geographic locations and/or zoom levels can be used to provide a viewpoint for the object of interest in the imagery.

### FIELD

The present disclosure relates generally to geographic information systems.

### BACKGROUND

Geographic information systems provide for the archiving, retrieving, and manipulating of data that has been stored and indexed according to geographic coordinates of its elements. Geographic information systems and other services can allow a user to request geographic imagery associated with an object or location of interest. For instance, a user may request imagery associated with a particular store, location, landmark, etc. The geographic information system can provide geographic imagery depicting the object or location of interest in response to the request to the user.

Geographic information systems can offer imagery of geographic regions of interest in a variety of different formats and from a variety of different view perspectives. For instance, geographic imagery can be provided as map imagery, satellite imagery, aerial imagery, interactive panoramic imagery presented from a perspective at or near ground level, and other imagery. Certain geographic information systems or services can provide interactive three-dimensional representations of a geographic area. Users can navigate a virtual camera to view the three-dimensional representations from a plurality of different perspectives.

Geographic information systems or other services can include or have access to a database of geolocated text. The geolocated text can include a plurality of text data objects that include text (e.g. a string) and geolocation information (e.g. geographic coordinates) associating the text with a particular geographic location. The database of geolocated text can include locally observed text in a geographic area.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of identifying a viewpoint for displaying geographic imagery. The method includes receiving, by the one or more computing devices, data indicative of a request for geographic imagery associated with an object and accessing, by the one or more computing devices, a multi-resolution textual descriptors map for a geographic area. The multi-resolution textual descriptors map associates geolocated text to one or more geographic locations in the geographic area at a plurality of varying zoom levels relative to the geographic area. The method further includes determining, by the one or more computing devices, a viewpoint for displaying geographic imagery associated with the object based at least in part on the multi-resolution textual descriptors map and providing, by the one or more computing devices, data for viewing geographic imagery associated with the object from the viewpoint.

Other example aspects of the present disclosure are directed to systems, apparatus, tangible, non-transitory computer-readable media, user interfaces, memory devices, and electronic devices for identifying a viewpoint for displaying geographic imagery.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for identifying imagery views using a multi-resolution textual descriptors map according to example aspects of the present disclosure;

FIG. 2 depicts a representation of an example multi-resolution textual descriptors map according to example aspects of the present disclosure;

FIG. 3 depicts an example data structure for a multi-resolution textual descriptors map according to example aspects of the present disclosure;

FIG. 4 depicts a flow diagram of an example method according to example aspects of the present disclosure;

FIG. 5 depicts the example traversal of a node tree data structure to identify a viewpoint for geographic imagery according to example aspects of the present disclosure; and

FIG. 6 depicts an example computing system according to example aspects of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Example aspects of the present disclosure are directed to identifying views for geographic imagery using locally observed text. More specifically, geographic information systems (e.g. a mapping service, a virtual globe application, etc.) and other services can allow a user to request geographic imagery associated with an object of interest. For instance, a user may request imagery associated with a particular store, object, item, product, location, landmark, street, point of interest, etc. The geographic information system can provide geographic imagery depicting the object of interest in response to the request to the user.

Geographic information systems can offer imagery of geographic regions in a variety of different formats and from a variety of different view perspectives. For instance, geographic imagery can be provided as map imagery, satellite imagery, aerial imagery, interactive panoramic imagery presented from a perspective at or near ground level, and other imagery. Certain geographic information systems or services can provide interactive three-dimensional representations of a geographic area. Users can navigate a virtual camera to view the three-dimensional representations from a plurality of different perspectives. Given the volume of different possible views available, it can be beneficial to have a standard or default view associated with a particular object or landmark that can be provided in response to a simple request for geographic imagery or other information associated with the landmark.

According to example aspects of the present disclosure, a viewpoint can be determined for displaying geographic imagery responsive to a request based on a corpus of geolocated text (e.g. locally observed text) in the geographic area. More particularly, a multi-resolution textual descriptors map associating text with specific geographic locations and one or more of a plurality of varying zoom levels relative to the geographic area can be accessed and used to identify a viewpoint for geographic area. The multi-resolution textual descriptors map can be a collection of data that associates text objects from the geolocated text with specific geographic coordinates. In addition, the multi-resolution textual descriptors map associates text objects with one or more zoom levels such that as one “zooms in” or “zooms out” relative to the geographic area, the text objects associated with the geographic area become more specific or more general respectively. For example, text objects associated with a coffee and tea aisle at a distant zoom level in the multi-resolution textual descriptors map might just say “coffee”, but as one zooms in the text becomes “french roast”, “italian roast”, “espresso roast.” As another example, a multi-resolution textual descriptors map of a library can associate scale specific text for many different zoom levels with the text being taken from the titles of books and other media in the library.

In particular implementations of the present disclosure, geographic locations and/or zoom levels corresponding to a text object describing or otherwise associated with the object of interest can be identified from the multi-resolution textual descriptors map. A view encompassing the identified geographic locations and/or zoom levels can be used to provide a viewpoint for the object of interest in the geographic imagery.

As an example, a user can perform a search using one or more search terms for geographic imagery associated with a particular landmark in a geographic information system, such as a mapping service, virtual globe application, search service, or other service. The search terms can include a textual description or identification of an object of interest. In response to the query, a multi-resolution textual descriptors map can be accessed and analyzed to identify text objects corresponding to the search query or to the object of interest. A geographic region and/or zoom level associated with the identified text objects can be determined from the multi-resolution textual descriptors map. Imagery associated with the identified geographic region and/or zoom level can then be provided for display to the user by the geographic information system or other service.

As another example, a user can enter a search for a particular product when viewing interactive panoramic imagery (e.g. an indoor panorama) associated with a commercial establishment. In response to the query, the multi-resolution textual descriptors map can be accessed and analyzed to identify a location and zoom level associated with the particular product in the multi-resolution textual descriptors map. Imagery corresponding to the location and zoom level identified from the multi-resolution textual descriptors map can be provided for display to the user by the geographic information system or other service.

The multi-resolution textual descriptors map can be generated from any corpus of geolocated text. Example sources of geolocated text can include text extracted from geographic imagery (e.g. using optical character recognition techniques), text associated with business listings in a geographic area, text associated with products offered at an establishment, geolocated commentary or reviews, text annotations associated with geolocated photos, and/or other geolocated text. In a particular implementation, the corpus of geolocated text can be representative of locally observed text (e.g. text that is visible on signage, storefronts, etc.) in a geographic area.

In one example implementation, the multi-resolution textual descriptors map can be based on a node tree data structure. The node tree data structure can include a plurality of nodes arranged in a plurality of hierarchical levels in parent-child relationship with a root node representing the entire mapped geographic area. The root node can have a plurality of child nodes in a first hierarchical level with each child node representing a sub-division of the mapped geographic area. Each child node can have a plurality of child nodes corresponding to further subdivisions in hierarchical fashion. Each hierarchical level in the node tree data structure can correspond to a particular zoom level of the multi-resolution textual descriptors map.

The content of each node in the node tree data structure can be a set of the text objects located in the geographic area corresponding to the node. Each text object can have a count indicating how many times the text object occurs within the area represented by the node. The multi-resolution textual descriptors map can be constructed by associating each occurrence of a text object with a node corresponding to the geolocation of the text object in the most zoomed in hierarchical level of the node tree data structure. The text object can then be recursively added to parent nodes among the plurality of hierarchical levels up to the root node of the node tree data structure.

Relevance scores can be computed for the text objects in each of the nodes based at least in part on a frequency of the text object in a geographic area relative to the frequency of the text object in neighboring nodes. For instance, normalized derivatives of each text object along each edge of the node tree data structure can be computed. The normalized derivatives reflect the significance of how the text object changes with spatial granularity. More particularly, when a text object is increasing in frequency with respect to its neighbors, it is assigned a higher relevance score.

The multi-resolution textual descriptors map can be accessed and used to determine a viewpoint for an object of interest in a variety of manners. For instance, one or more text objects describing or otherwise associated with the object of interest can be identified. In one implementation, the one or more text objects can include search terms entered as part of the request for geographic imagery of the object of interest. The multi-resolution textual descriptors map can be accessed to identify information associated with the one or more text objects. The information can be used to identify the viewpoint for the object of interest. In one example, a node tree data structure representing the multi-resolution textual descriptors map can be traversed to identify nodes associated with the identified text objects and having a relevance score exceeding a threshold. The viewpoint can be determined to view imagery corresponding to the identified nodes. In another example, the viewpoint can be determined at least in part by identifying the zoom level and/or geographic locations in the multi-resolution textual descriptors map having a threshold percentage of text objects associated with the object of interest. The viewpoint can view the geographic locations from the identified zoom level.

### Example Identification of Imagery Views Using Textual Descriptors Map

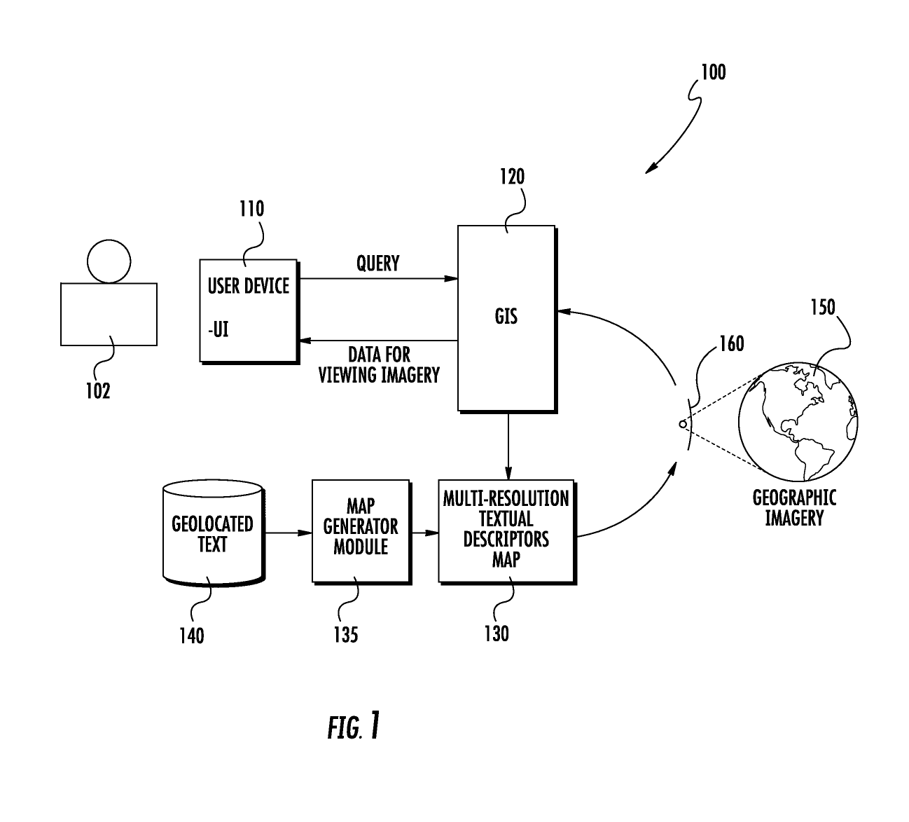

FIG. 1 depicts an example system 100 for identifying imagery views using a multi-resolution textual descriptors map according to example aspects of the present disclosure. A user 102 can access the system 100 via a user device 110. The user device 110 can be any suitable computing device, such as a desktop, laptop, smartphone, mobile device, tablet, wearable computing device, navigation system, display with one or more processors, etc. The user device 110 can provide a suitable user interface (e.g. a browser) that allows the user 102 to access and interface with the system 100.

The user 102 can send a request or query to a geographic information system 120 to view imagery associated with a particular object of interest. For example, the user 102 can search for imagery associated with Landmark A in a three-dimensional representation of a geographic area provided by the geographic information system 120. As another example, the user 102 can search for imagery associated with Product X in interactive panoramic imagery depicting the interior of a commercial establishment provided by the geographic information system 120. The query can include one or more search terms describing the object of interest.

Upon receiving the request for imagery, the geographic information system 120 can identify data for displaying imagery associated with the object of interest. According to example aspects of the present disclosure, the data for displaying the imagery can be identified by accessing a multi-resolution textual descriptors map 130. The multi-resolution textual descriptors map 130 can associate text objects with geographic coordinates at a plurality of different zoom levels relative to the geographic area. In particular implementations, the multi-resolution textual descriptors map 130 can identify one or more text objects for each geographic location and zoom level based on a relevance score associated with the text objects. The relevance score can be indicative of the importance of the text object at a specific geographic location and zoom level. Details concerning an example multi-resolution textual descriptors map will be discussed below.

The multi-resolution textual descriptors map 130 can be generated from a database of geolocated text 140 using, for instance, a textual descriptors map generator module 135. The database of geolocated text 140 can be any corpus of text objects having geographic coordinates. In particular implementations, the database of geolocated text 140 can be locally observed text. Example sources of geolocated text can include text extracted from geographic imagery (e.g. using optical character recognition techniques), text associated with business listings in a geographic area, text associated with products offered at an establishment, geolocated commentary or reviews, text annotations associated with geolocated photos, and/or other geolocated text.

As shown in FIG. 1, the geographic information system 120 can access the multi-resolution textual descriptors map 130 and can determine a viewpoint 160 for viewing geographic imagery 150 based on the information in the multi-resolution textual descriptors map 130. The viewpoint can provide a view of the object of interest in the geographic imagery from a particular zoom level and/or virtual camera perspective. The viewpoint can be determined by identifying one or more text objects associated with the object of interest in the multi-resolution textual descriptors map. Information associated with the one or more text objects can be used to determine the viewpoint.

For instance, a viewpoint can be determined to view a portion of the geographic area encompassing a threshold percentage of the geographic locations having text objects associated with the object of interest in the multi-resolution textual descriptors map. In another example, the viewpoint can be determined based at least in part on the relevance scores associated with text objects in the multi-resolution textual descriptors map.

Once the viewpoint is determined, the geographic information system 120 can provide data for displaying geographic imagery associated with the object of interest from the determined viewpoint 160. The geographic imagery of the object of interest can then be presented on a display associated with the user device 110 in a suitable user interface from the determined viewpoint 160. In this way, the system 100 can return geographic imagery depicting the object of interest from an ideal viewpoint responsive to a simple search query associated with the object of interest.

### Example Multi-Resolution Textual Descriptors Map

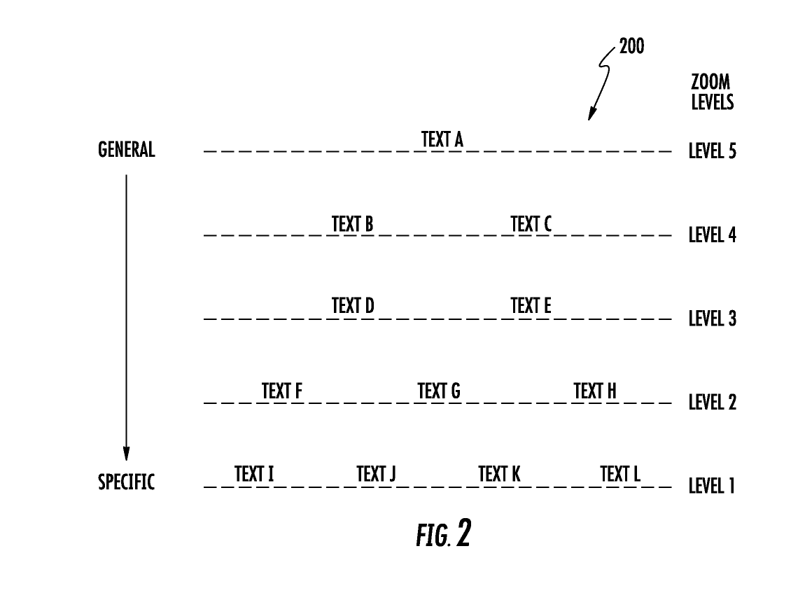

FIG. 2 depicts a representation of an example multi-resolution textual descriptors map 200 according to example aspects of the present disclosure. The multi-resolution textual descriptors map 200 has a plurality of zoom levels relative to a geographic area 210. The geographic area 210 can be representative of any geographic location of interest, such as the interior of a commercial establishment, a street, a city, a state, a country, the world, etc.

The textual descriptors map 200 can associate text objects with specific geographic locations (e.g. latitude/longitude/altitude coordinates; x, y positions, or other coordinates) within the geographic area 210 and with specific zoom levels relative to the geographic area 210. In the example of FIG. 2, the multi-resolution textual descriptors map 200 associates text objects with one of five different zoom levels: Level 1, Level 2, Level 3, Level 4, and Level 5. Level 1 is the most zoomed in level of the multi-resolution textual descriptors map 200. Level 5 is the most zoomed out level of the multi-resolution textual descriptors map 200. More general terms can be associated with broader geographic areas and more zoomed out zoom levels. More specific terms can be associated with narrower geographic areas and more zoomed in zoom levels.

In the example multi-resolution textual descriptors map 200 of FIG. 2, text object Text A is associated with Level 5 of the multi-resolution textual descriptors map 200. Text objects Text B and Text C are associated with Level 4 of the multi-resolution textual descriptors map 200. Text objects Text D and Text E are associated with Level 3 of the multi-resolution textual descriptors map 200. Text objects Text F, Text G and Text H are associated with Level 2 of the multi-resolution textual descriptors map 200. Text object Text I, Text J, Text K and Text L are associated with Level 1 of the multi-resolution textual descriptors map 200.

The multi-resolution textual descriptors map 200 can associate a geolocated text object with a particular geographic location and zoom level in the multi-resolution textual descriptors map 200 based on spatial granularity of the text objects. For instance, text objects that increase in frequency at a particular geographic location and/or zoom level relative to other text objects can be assigned to the particular geographic location and zoom level in the multi-resolution textual descriptors map.

In this way, the multi-resolution textual descriptors map 200 can provide a logical organization of text objects, such as locally observed text, in a geographic area. More particularly, locally distinctive text objects can be organized by not only geographic location but also zoom level relative to the geographic area. Incorporating the plurality of varying zoom levels in the multi-resolution textual descriptors map 200 allows for the organization of text objects depending on a desired granularity associated with the text objects.

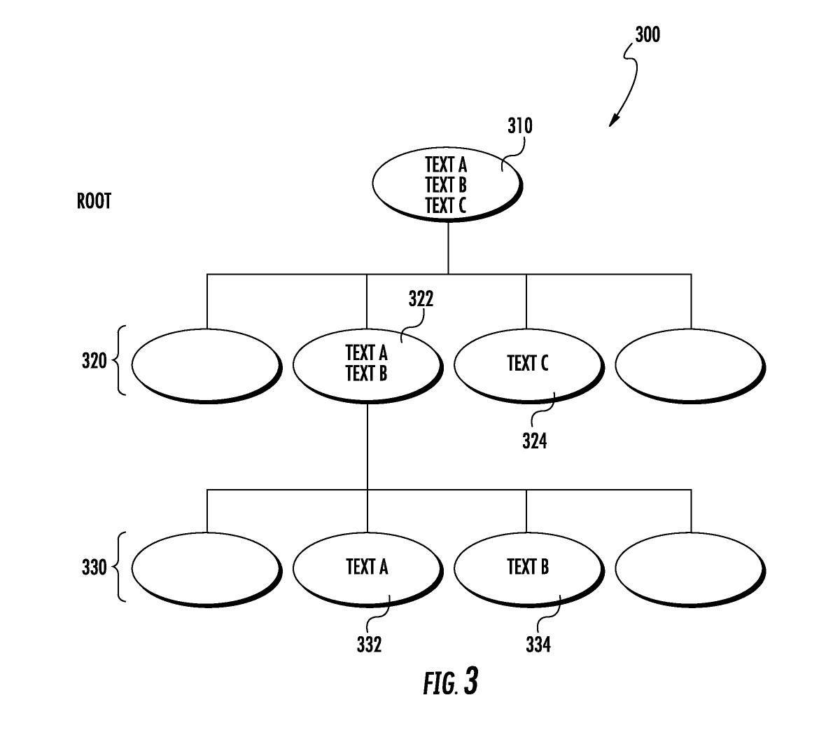

In one example implementation, the multi-resolution textual descriptors map can be based on a node tree data structure having a plurality of hierarchical levels arranged in parent-child relationship. An example node tree data structure 300 is depicted in FIG. 3. The node tree data structure 300 includes a root node 310. The root node 310 can correspond to the entire geographic area represented by the multi-resolution textual descriptors map. The root node 310 has a plurality of child nodes 320 arranged in a first hierarchical level. Each of the child nodes 320 can represent a sub-division of the geographic area represented by the root node 310. Each of the child nodes 320 can have their own children nodes, such as child nodes 330 arranged in a second hierarchical level. Each of the child nodes 330 in the second hierarchical level can be a further sub-division of the geographic area associated with one of the child nodes 320 in the first hierarchical level. The sub-division of geographic areas into child nodes can continue in hierarchical fashion among a plurality of hierarchical levels of the node tree data structure 330. While only two hierarchical levels beyond the root node 310 are depicted in FIG. 3 for purposes of illustration and discussion, those of ordinary skill in the art, using the disclosures provided herein, will understand that the node tree data structure can include any number of hierarchical levels without deviating from the scope of the present disclosure.

Each hierarchical level in the node tree data structure 300 can correspond to a zoom level in the multi-resolution textual descriptors map. For instance, the root node 310 can correspond to a most zoom out level in the multi-resolution textual descriptors map. The first hierarchical level in the node tree data structure 300 can correspond to different zoom level in the multi-resolution textual descriptors map. The second hierarchical level in the node tree data structure 300 can correspond to yet a different zoom level in the multi-resolution textual descriptors map, and so forth.

Each node in the node tree data structure can include one or more text objects that are geolocated in the geographic area corresponding to the node. The text objects can also have a count indicative of the frequency of occurrence of the text object in the geographic area and a relevance score associated with the text object. The relevance score can be indicative of the importance of the text object at a particular zoom level in the multi-resolution textual descriptors map. The relevance scores can be used to associate text objects with particular zoom levels and geographic locations in the multi-resolution textual descriptors map. For instance, text objects with higher relevance scores at a particular zoom level and geographic location can be associated with the particular zoom level and geographic location in the multi-resolution textual descriptors map.

The node tree data structure can be constructed, for instance using the textual descriptors map generator module 135 of FIG. 1, by first populating each node in the hierarchical level corresponding to the most zoomed in level of the multi-resolution textual descriptors map with text objects having geographic coordinates or geolocation information associated with the geographic area corresponding to the node. For instance, in the example node tree data structure 300 of FIG. 3, text object Text A can be associated with a first node 332 of the node tree data structure 300 because it has geolocation information corresponding to the geographic area associated with the first node 332. Similarly, text object Text B can be associated with as second node 334 of the node tree data structure 300 because it has geolocation information corresponding to the geographic area associated with the second node 334.

Each text object can then be recursively added to each parent node among the plurality of hierarchical levels up to the root node of the node tree data structure. For instance, referring to the node tree data structure 300 of FIG. 3, text object Text A can be added to the parent node 322 of node 332. Similarly, text object Text B can be added to the parent node 322 of node 334. Text object C can be added to parent node 324 based on its occurrence in a child node of node 324 (not illustrated). Text objects Text A, Text B, and Text C can then be added to the root node 310 such that the root node contains text objects for the entire geographic area represented by the node tree data structure 300.

A count can be maintained for each text object in a node indicative of the frequency of occurrence of the text object in the geographic area corresponding to the node. The node tree data structured can then be traversed to compute a partial derivative of each text object along each edge of the node tree data structure. The partial derivative reflects how the significance of the label changes when moving from one zoom level to another zoom level. The relevance score for each text object in a node can be computed based on the partial derivative. In this manner, a text object that is increasing in frequency with respect to its neighbors can have a high relevance score and can thus be considered more important for a particular zoom level.

For example, the text object “coffee” can appear with high frequency in the espresso section of a commercial establishment. However, it does not appear at any higher frequency than the level above the espresso section (e.g. the general coffee aisle). The text object “Espresso” on the other hand, increases in relative frequency when moving from the zoom level associated with the general coffee aisle to the zoom level associated with the espresso section. Accordingly, the text object “Espresso” can be assigned a higher relevance score than “coffee” for the node corresponding to the espresso section. Other factors can be considered when computing a relevance score for a particular text object.

The relevance scores can be used to associate text objects with various geographic positions and/or zoom levels in the multi-resolution textual descriptors map in a variety of manners. For instance, each node of the node tree data structure can be analyzed to rank text objects for the node based on relevance score. One or more text objects can be selected for a particular geographic area and zoom level represented by the node based on the ranking of the text objects. For instance, the highest ranked text objects can be associated with the geographic position and zoom level corresponding to the node in the multi-resolution textual descriptors map.

Once the node tree data structure has been constructed, in can be access to identify viewpoints for geographic imagery according to example aspects of the present disclosure. For instance, in one implementation, the node corresponding to the highest relevance score for a text object describing the object of interest can be identified. The view of the geographic imagery corresponding to the node can be identified as the viewpoint for the geographic imagery.

### Example Method for Identifying Views Using Multi-Resolution Textual Descriptors Map

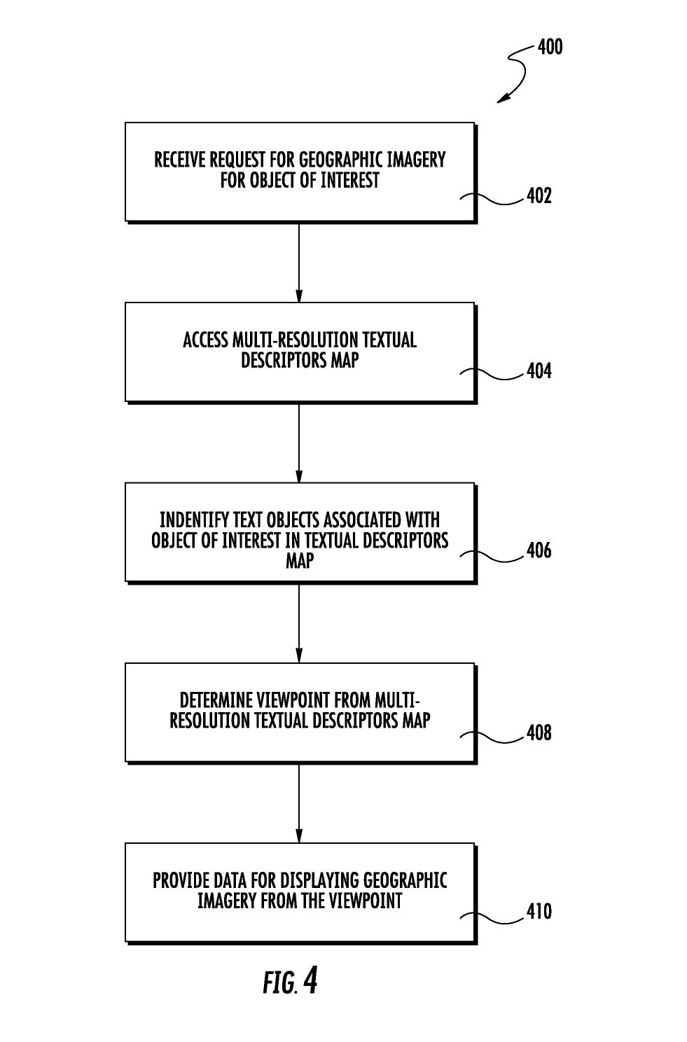

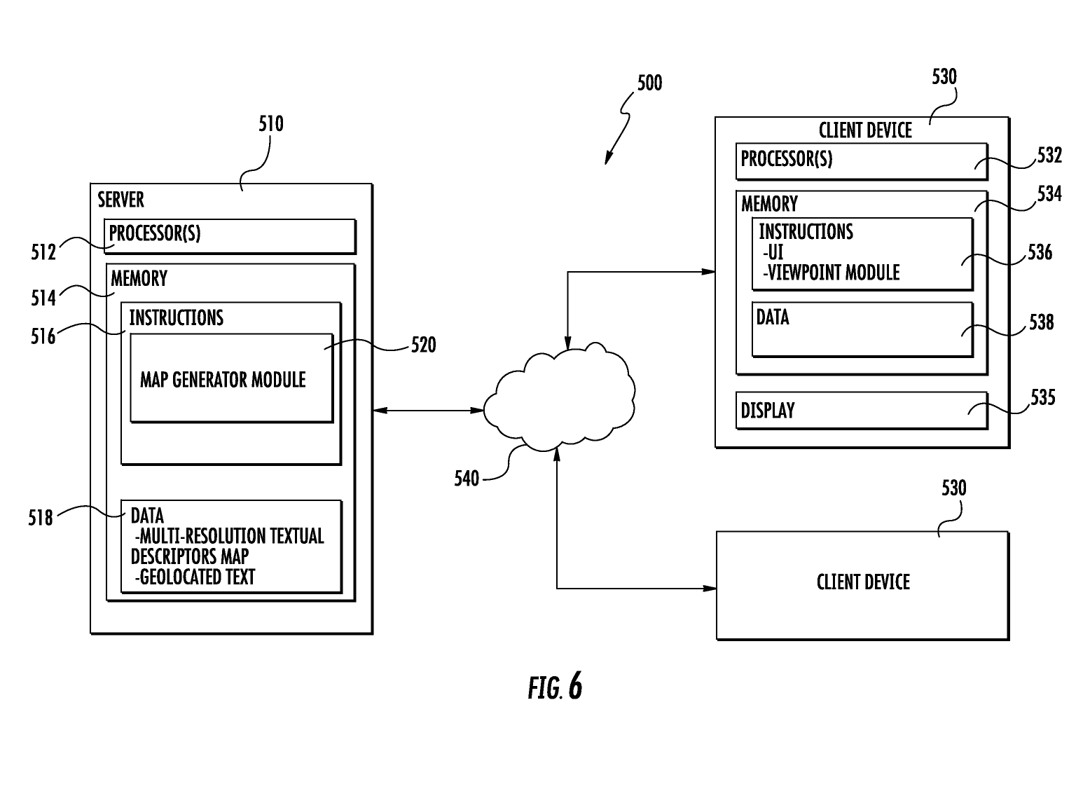

FIG. 4 depicts a flow diagram of an example method (400) for identifying viewpoints for geographic imagery according to example aspects of the present disclosure. FIG. 4 can be implemented by one or more computing devices, such as one or more of the computing devices depicted in FIG. 6. In addition, FIG. 4 depicts steps performed in a particular order for purposes of illustration and discussion. Those of ordinary skill in the art, using the disclosures provided herein, will understand that

At (402), the method includes receiving a request for geographic imagery for an object of interest. For instance, a geographic information system can receive a request for geographic imagery and/or other information associated with an object of interest. In particular implementations, the request can include one or more search terms entered into a search tool associated with the geographic information system. The search tool can allow a user to search the geographic information system and other databases for information associated with the search terms, including geographic imagery associated with an object of interest described by the search terms.

At (404), the method includes accessing a multi-resolution textual descriptors map. The multi-resolution textual descriptors map can associate text objects with geographic positions and one or more of a plurality of varying zoom levels relative to the geographic area. The multi-resolution textual descriptors map can be generated from a corpus of geolocated text, such as a corpus of locally observed text in the geographic area. The multi-resolution textual descriptors map can be based on a node tree data structure, such as the node tree data structure depicted in FIG. 3.

At (406), the method includes identifying one or more text objects associated with the object of interest in the multi-resolution textual descriptors map. The one or more text objects can be text objects that describe the object of interest, identify the object of interest, or are otherwise associated with the object of interest. In one particular implementation, the identified text objects correspond to search terms provided as part of a request for geographic imagery.

At (408), the view is determined based at least in part on information associated with the identified text object in the multi-resolution textual descriptors map. For instance, in one embodiment, the view is determined by identifying geographic positions and zoom levels in the multi-resolution textual descriptors map corresponding to the identified text objects associated with the object of interest. Geographic positions and/or zoom levels having a threshold percentage of the total number of text objects associated with the object of interest can be used to determine the viewpoint for the geographic imagery of the object of interest. For instance, the viewpoint can have a zoom level corresponding to the zoom level identified in the multi-resolution textual descriptors map.

In another embodiment, the viewpoint can be identified by traversing a node tree data structure representing the multi-resolution textual descriptors map to identify one or more nodes having relevance values for the text objects that exceed a threshold. In one particular implementation, the node with the highest relevance value for text object associated with the object of interest can be identified. The viewpoint can be determined to view the geographic area represented by the node at a zoom level corresponding to the hierarchical level of the node in the node tree data structure.

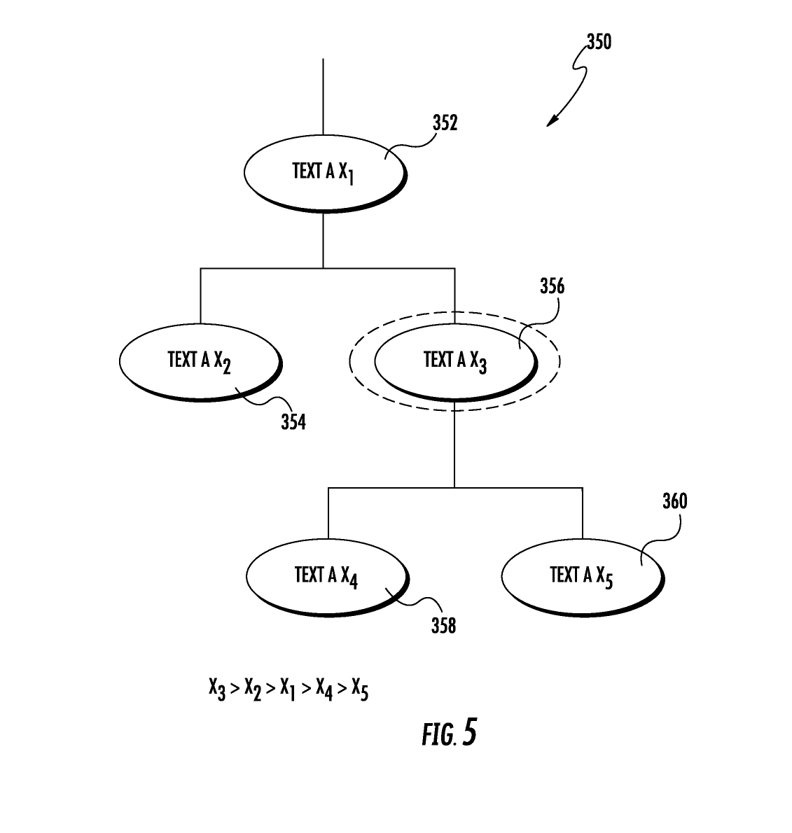

For example, FIG. 5 depicts a portion of an example node tree data structure 350 containing text objects Text A associated with an object of interest. The node tree data structure 350 can contain nodes 352, 354, 356, 358, and 360 all containing the text object Text A. Each of the nodes 352, 354, 356, 358, and 360 has a relevance score for Text Object A indicative of the importance of the text object at the geographic position and zoom level associated with the node. More particularly, node 352 has a relevance score x1 associated with text object Text A. Node 354 has a relevance score x2 associated with text object Text A. Node 356 has a relevance score x3 associated with text object Text A. Node 358 has a relevance score x4 associated with text object Text A. Node 360 has a relevance score x5 associated with text object Text A.

The relevance score x3 can be greater than relevance scores x2, x1, x4, and x5. Accordingly node 356 can be identified as the node corresponding to the highest relevance score for text object Text A. The node 356 is associated with a particular geographic area and a particular zoom level. The zoom level of node 356 corresponds to the hierarchical level of node 356 in the node tree data structure 350. The viewpoint can be determined to view the geographic area corresponding to the node 356 at the zoom level corresponding to the hierarchical level of the node 356

Referring back to FIG. 4 at (410), the method can include providing data for displaying geographic imagery from the viewpoint. For instance, a view specification describing the geographic imagery from the determined viewpoint can be provided. Geographic imagery depicting the object of interest can be displayed in accordance with the view specification.

### Example Computing System for Identifying Imagery Views Using a Multi-Resolution Textual Descriptors Map

FIG. 6 depicts a computing system 500 that can be used to implement the methods and systems according to example aspects of the present disclosure. The system 500 can be implemented using a client-server architecture that includes a server 510 that communicates with one or more client devices 530 over a network 540. The system 500 can be implemented using other suitable architectures, such as a single computing device.

The system 500 includes a server 510, such as a web server. The server 510 can host a geographic information system. The server 510 can be implemented using any suitable computing device(s). The server 510 can have one or more processors 512 and memory 514. The server 510 can also include a network interface used to communicate with one or more client devices 530 over the network 540. The network interface can include any suitable components for interfacing with one more networks, including for example, transmitters, receivers, ports, controllers, antennas, or other suitable components.

The one or more processors 512 can include any suitable processing device, such as a microprocessor, microcontroller, integrated circuit, logic device, or other suitable processing device. The memory 514 can include one or more computer-readable media, including, but not limited to, non-transitory computer-readable media, RAM, ROM, hard drives, flash drives, or other memory devices. The memory 514 can store information accessible by the one or more processors 512, including computer-readable instructions 516 that can be executed by the one or more processors 512. The instructions 516 can be any set of instructions that when executed by the one or more processors 512, cause the one or more processors 512 to perform operations. For instance, the instructions 516 can be executed by the one or more processors 512 to implement one or more modules, such as map generator module 520 for generating a multi-resolution textual descriptors map according to example aspects of the present disclosure.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into one or more memory devices and executed by one or more processors or can be provided from computer program products, for example computer executable instructions, that are stored in a tangible computer-readable storage medium such as RAM, hard disk or optical or magnetic media. When software is used, any suitable programming language or platform can be used to implement the module.

Memory 514 can also include data 518 that can be retrieved, manipulated, created, or stored by the one or more processors 512. The data 518 can include, for instance, a multi-resolution textual descriptors map, geographic imagery, a corpus of geolocated text, etc. The data 518 can be stored in one or more databases. The one or more databases can be connected to the server 510 by a high bandwidth LAN or WAN, or can also be connected to server 510 through network 540. The one or more databases can be split up so that they are located in multiple locales.

The server 510 can exchange data with one or more client devices 530 over the network 540. Although two client devices 530 are illustrated in FIG. 6, any number of client devices 530 can be connected to the server 510 over the network 540. Each of the client devices 530 can be any suitable type of computing device, such as a general purpose computer, special purpose computer, laptop, desktop, mobile device, navigation system, smartphone, tablet, wearable computing device, a display with one or more processors, or other suitable computing device.

Similar to the server 510, a client device 530 can include one or more processor(s) 532 and a memory 534. The one or more processor(s) 532 can include one or more central processing units (CPUs), graphics processing units (GPUs) dedicated to efficiently rendering images or performing other specialized calculations, and/or other processing devices. The memory 534 can include one or more computer-readable media and can store information accessible by the one or more processors 532, including instructions 536 that can be executed by the one or more processors 532 and data 538. For instance, the memory 534 can store instructions 536 for implementing a user interface module for displaying geographic imagery from a viewpoint determined according to example aspects of the present disclosure. The instructions 536 can also be used to implement a viewpoint module configured to identify a viewpoint for displaying geographic imagery associated with an object of interest according to example aspects of the present disclosure.

The client device 530 of FIG. 6 can include various input/output devices for providing and receiving information from a user, such as a touch screen, touch pad, data entry keys, speakers, and/or a microphone suitable for voice recognition. For instance, the client device 530 can have a display 535 for presenting a user interface displaying geographic imagery according to example aspects of the present disclosure.

The client device 530 can also include a network interface used to communicate with one or more remote computing devices (e.g. server 510) over the network 540. The network interface can include any suitable components for interfacing with one more networks, including for example, transmitters, receivers, ports, controllers, antennas, or other suitable components.

The network 540 can be any type of communications network, such as a local area network (e.g. intranet), wide area network (e.g. Internet), cellular network, or some combination thereof. The network 540 can also include a direct connection between a client device 530 and the server 510. In general, communication between the server 510 and a client device 530 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of identifying a viewpoint for displaying geographic imagery, the method comprising:
receiving, by one or more computing devices, data indicative of a request for geographic imagery associated with an object;
accessing, by the one or more computing devices, a multi-resolution textual descriptors map for a geographic area, the multi-resolution textual descriptors map associating geolocated text to one or more geographic locations in the geographic area at a plurality of varying zoom levels relative to the geographic area;
determining, by the one or more computing devices, a viewpoint for displaying geographic imagery associated with the object based at least in part on the multi-resolution textual descriptors map; and
providing, by the one or more computing devices, data for viewing geographic imagery associated with the object from the viewpoint.

2. The computer-implemented method of claim 1, wherein the multi-resolution textual descriptors map associates more specific text objects with more zoomed in levels of the plurality of varying zoom levels of the multi-resolution textual descriptors map.

3. The computer-implemented method of claim 1, wherein the multi-resolution textual descriptors map associates a geolocated text object with one or more of the plurality of varying zoom levels based at least in part on a frequency of the geolocated text object in a geographic area relative to the frequency of the text object in other geographic areas.

4. The computer-implemented method of claim 1, wherein the method comprises identifying a text object associated with the object in the multi-resolution textual descriptors map.

5. The computer-implemented method of claim 4, wherein the viewpoint is determined based at least in part on information associated with the identified text object associated with the object in the multi-resolution textual descriptors map.

6. The computer-implemented method of claim 5, wherein the information comprises a zoom level and geographic position corresponding to the identified text object.

7. The computer-implemented method of claim 1, wherein the multi-resolution textual descriptors map is based on a node tree data structure having a plurality of nodes arranged in a plurality of hierarchical levels in parent-child relationship, each hierarchical level in the node tree data structure corresponding to one of the plurality of zoom levels of the multi-resolution textual descriptors map.

8. The computer-implemented method of claim 7, wherein the node tree data structure is constructed from the geolocated text by associating each occurrence of a geolocated text object with a node corresponding to the geolocation of the text object in the hierarchical level corresponding to the most zoomed in level of the multi-resolution textual descriptors map, and recursively adding the text object to each parent node of the node corresponding to the geolocation of the text object among the plurality of hierarchical levels up to a root node of the node tree data structure.

9. The computer-implemented method of claim 8, wherein the multi-resolution textual descriptors map is generated at least in part by traversing the node tree data structure and generating a relevance score for each text object in a node based at least in part on the frequency of the text object relative to one or more neighboring nodes in the node tree data structure.

10. The computer-implemented method of claim 9, wherein the viewpoint is determined by traversing the node tree data structure to identify a node based at least in part on a relevance score for a text object associated with the object in the multi-resolution textual descriptors map.

11. The computer-implemented method of claim 1, wherein the geolocated text comprises a plurality of text objects extracted from imagery captured of the geographic area by a camera.

12. The computer-implemented method of claim 1, wherein the geolocated text comprises a plurality of text objects associated with business listings in the geographic area.

13. A computing system, comprising:
one or more processors; and
one or more memory devices, the one or more memory devices comprising computer-readable instructions that when executed by the one or more processors cause the one or more processors to perform operations, the operations comprising:
receiving data indicative of a request for geographic imagery associated with an object;
accessing a multi-resolution textual descriptors map for a geographic area, the multi-resolution textual descriptors map associating geolocated text to one or more geographic locations in a geographic area at a plurality of varying zoom levels relative to the geographic area;
determining a viewpoint for displaying geographic imagery associated with the object based at least in part on the multi-resolution textual descriptors map; and
providing data for viewing geographic imagery associated with the object from the viewpoint.

14. The computing system of claim 13, wherein the multi-resolution textual descriptors map associates a geolocated text object with one or more of the plurality of varying zoom levels based at least in part on a frequency of the geolocated text object in a geographic area relative to the frequency of the text object in other geographic areas.

15. The computing system of claim 13, wherein the viewpoint is determined based on information corresponding to a geolocated text object associated with the object in the multi-resolution textual descriptors map.

16. The computing system of claim 15, wherein the viewpoint has a zoom level corresponding to a zoom level associated with the geolocated text object identified in the multi-resolution textual descriptors map.

17. The computing system of claim 16, wherein the zoom level identified in the multi-resolution textual descriptors map encompasses a threshold percentage of geolocated text objects describing the object in the multi-resolution textual descriptors map.

18. One or more tangible, non-transitory computer-readable media storing computer-readable instructions that when executed by one or more processors cause the one or more processors to perform operations, the operations comprising:
receiving data indicative of a request for geographic imagery associated with a object;
accessing a multi-resolution textual descriptors map for a geographic area, the multi-resolution textual descriptors map associating geolocated text to one or more geographic locations in a geographic area at a plurality of varying zoom levels relative to the geographic area;
determining a viewpoint for displaying geographic imagery associated with the object based at least in part on the multi-resolution textual descriptors map; and
providing data for viewing geographic imagery associated with the object from the viewpoint.
wherein the multi-resolution textual descriptors map is based on a node tree data structure having a plurality of nodes arranged in a plurality of hierarchical levels in parent-child relationship, each hierarchical level in the node tree data structure corresponding to one of the plurality of zoom levels of the multi-resolution textual descriptors map, the node tree data structure is constructed from the geolocated text by associating each occurrence of a geolocated text object with a node corresponding to the geolocation of the text object in the hierarchical level corresponding to the most zoomed in level of the multi-resolution textual descriptors map, and recursively adding the text object to each parent node of the node corresponding to the geolocation of the text object among the plurality of hierarchical levels up to a root node of the node tree data structure.

19. The one or more tangible, non-transitory computer-readable media of claim 18, wherein the multi-resolution textual descriptors map is generated at least in part by traversing the node tree data structure and generating a relevance score for each text object in a node based at least in part on the frequency of the text object relative to one or more neighboring nodes in the node tree data structure.

20. The one or more tangible, non-transitory computer-readable media of claim 18, wherein the viewpoint for displaying the geographic imagery associated with the object is determined based at least in part on the relevance score corresponding to a geolocated text object associated with the object in one or more nodes in the node tree data structure.
